(19) United States
(12) Patent Application Publication
(10) Pub. No.: US 2009/0241466 A1
(43) Pub. Date: Oct. 1, 2009

(54) Sealed Glass Unit and Method for Upgrading an Existing Curtain Wall

(76) Inventor: Efim Gussakovsky, Winnipeg (CA)

Correspondence Address: ADE & COMPANY INC., 2157 Henderson Highway, WINNIPEG, MB, R2G1P9, CA

(21) Appl. No.: 12/410,563

(22) Filed: Mar. 25, 2009

Related U.S. Application Data
(60) Provisional application No. 61/039,818, filed on Mar. 27, 2008.

(51) Int. Cl. E06B 3/66; E04G 23/00

(52) U.S. Cl. 52/786.1; 52/745.16

(57) ABSTRACT

A sealed glass unit is prefabricated for installation on an existing curtain wall frame having framing members defining channels of suitable width to receive a glass unit of N glass panes. The unit comprises N+1 glass panes arranged with adjacent panes in spaced apart, sealed and parallel relationships with one another. The panes include an outer glass pane of a first size and at least one smaller glass pane, the smaller glass pane being positioned inward from a peripheral edge of the outer glass plane. The unit is installed on the existing curtain wall to position outside edges of N out of the N+1 glass panes of the sealed unit, including the outer glass pane, into the channels of the corresponding framing members and position each remaining pane at a position further inward relative to an interior space of the building.

This application claims benefit under 35 U.S.C. 119(e) of U.S. Provisional Patent Application Ser. No. 61/039,818, filed Mar. 27, 2008.

### FIELD OF THE INVENTION

This invention relates generally to curtain walls and more particularly to a sealed glass unit and method for upgrading an existing curtain wall to increase the number of glass panes relative to a previously-installed glass unit being replaced.

### BACKGROUND OF THE INVENTION

Curtain wall systems used to form building facades or exteriors use a system of frame members assembled in a grid-like pattern to define an array of openings over each of which glass units or other panels are fitted to define the exterior appearance of the building and the location of glazed windows. The frame members of a curtain wall may be arranged to support single pane glass units or sealed insulated glass units of double or triple pane construction, depending for example on the age of curtain wall and the environment or climate in which the building is located.

To provide improved insulation of an existing curtain wall having single pane windows or glazing, it is known in the prior art to upgrade to multi-pane glass installations by adding an additional pane of glass in a sealing manner against the original single pane and securing the additional pane to the curtain wall frame, as shown in U.S. Pat. No. 4,089,143 of La Pietra. Alternatively, single pane glazing of an existing curtain wall may be upgraded to triple glazing by adding a sealed double-pane insulating glass unit arranged to seal against the original single pane and fastening it to the curtain wall frame, as shown in U.S. Patent Application Publication No. 2006/0286317. Upgrading a curtain wall by adding additional panes in this manner keeps the original glass in place during the upgrade installation, allowing continued occupancy of the affected space within the building as the installation avoids exposure of the building interior to the elements.

However, the addition of new glass panes in the field may not provide the same level of quality control as is achievable in the manufacture of factory-fabricated sealed insulating glass units, particularly with regard to the seal between the existing glass installation and the unit being added on-site. For example, field installed additions may create problems such as dust or moisture between the new glass unit and the existing glass installation, such trapped moisture problems being known to those of skill in the art, for example occurring as a result of broken seals in insulated glass units.

### SUMMARY OF THE INVENTION

According to a first aspect of the invention there is provided a sealed glass unit prefabricated for installation on an existing curtain wall frame having framing members defining channels of suitable width to receive a glass unit of N glass panes, the sealed glass unit comprising:

a plurality of glass panes interconnected to be movable together as a single assembled unit and comprising N+1 glass panes, adjacent panes of the plurality of glass panes being in spaced apart and parallel relationships with one another;

the plurality of glass panes comprising an outer glass pane of a first size and at least one smaller glass pane of a second size smaller than the first size, the smaller glass pane being positioned inward from a peripheral edge of the outer glass plane; and

the adjacent panes being sealed together along a perimeter of a space defined therebetween.

Preferably the plurality of glass panes comprises a middle pane disposed between and sealed to each of the outer glass pane and the small glass pane.

The middle pane may be generally equal in size to the outer pane and in general alignment therewith, the small pane being inwardly offset from a periphery of the aligned outer and middle panes. In this instance, preferably the middle pane and the small pane are sealed together along outside edges of the small pane.

There may be provided a window covering mechanism installed in the space defined between a respective pair of adjacent panes and operable between closed and open conditions, preferably between the inner and middle glass panes when provided.

Preferably the window covering mechanism comprises Venetian blinds operable between raised and lowered conditions.

Preferably the plurality of glass panes comprises three glass panes.

The plurality of glass panes may consist of N+1 glass panes.

Preferably the plurality of glass panes consists of three glass panes.

N may equal two in order to facilitate installation in a curtain wall frame originally intended to support double pane glass, or alternatively may equal two in order to facilitate installation in a curtain wall frame originally intended to support double pane glass.

According to a second aspect of the invention, there is provided a method for upgrading an existing curtain wall of a building, the curtain wall having framing members defining channels in which previously installed glass units each using N glass panes are received, the method comprising the steps of:

(a) manufacturing a sealed glass unit comprising N+1 glass panes arranged with adjacent panes in spaced apart, sealed and parallel relationships with one another, the N+1 panes comprising an outer glass pane of a first size and at least one smaller glass pane of a second size smaller than the first size, the smaller glass pane being positioned inward from a peripheral edge of the outer glass plane;

(b) removing one of the previously installed glass units from corresponding framing members of the existing curtain wall;

(c) installing the sealed glass unit on the existing curtain wall to position outside edges of N out of the N+1 glass panes of the sealed unit, including the outer glass pane, into the channels of the corresponding framing members and position each remaining pane at a position further inward relative to an interior space of the building along surfaces of the corresponding framing members from which the channels thereof are recessed.

Where the sealed glass unit comprises a window covering mechanism installed between a respective pair of adjacent panes, preferably the respective pair of adjacent panes does not comprise the outer glass pane.

Step (a) may comprise sealing the outer pane to a middle pane adjacent thereto at a temperature below −20 degrees Celsius, or alternatively may comprise sealing the outer pane to a middle pane adjacent thereto at an intentionally elevated air pressure greater than a naturally occurring range of atmospheric pressure.

### BRIEF DESCRIPTION OF THE DRAWINGS

In the accompanying drawings, which illustrate an exemplary embodiment of the present invention:

FIG. 1 is a cross sectional view of a triple pane insulated glass unit installed in a curtain wall framing assembly originally intended to support double pane insulated glass units.

### DETAILED DESCRIPTION

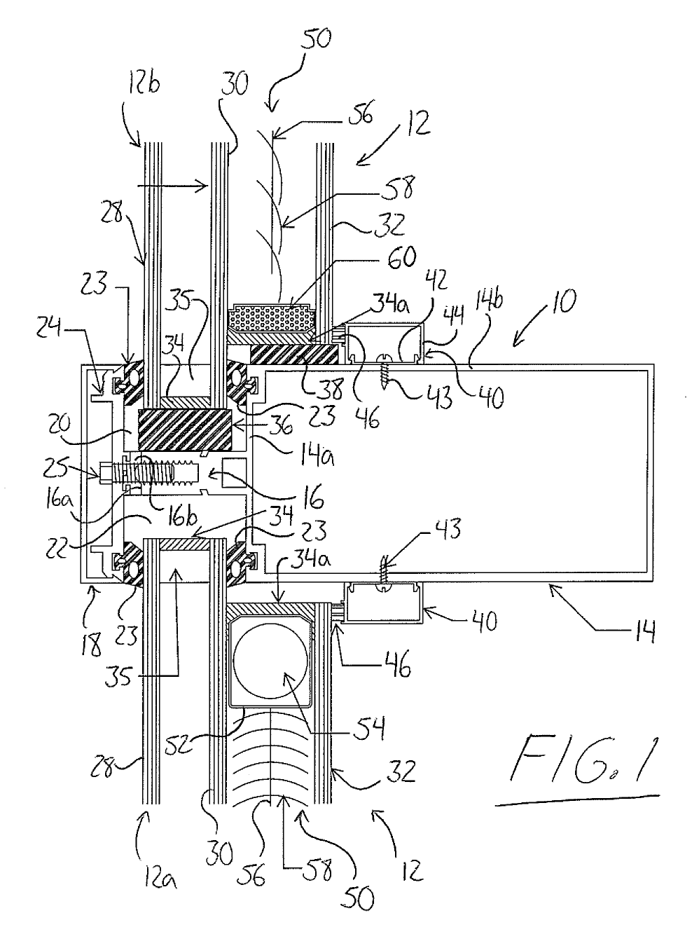

FIG. 1 shows a vertical cross section cut through a, for example, aluminum profile defining a horizontal frame member 10 of an existing conventionally structured curtain wall from which originally installed double pane insulating glass units have been removed and replaced with triple pane insulating glass units 12 according to an embodiment of the present invention. The profile of the frame member 10 defines a tubular portion 14 of the frame member having a generally rectangular periphery enclosing around the horizontal longitudinal axis of the tubular portion extending along the side of the building structure on which the curtain wall was previously installed. The profile of the frame member 10 further defines a projection 16 projecting from the tubular portion 14 in an outward direction away from the building structure on an outer side 14a of the tubular portion's periphery opposite the building structure at a central height along this side to define a central horizontal ledge extending along the tubular portion. A cap assembly 18 is fastened to a distal end 16a of the projection 16 opposite the tubular portion 14 of the frame member through a thermal break 16b, for example of PVC rubber, installed on the distal end 16a. In the vertical direction, the cap assembly 18 has a height matching that of the tubular portion 14 so as to project both upward and downward from the centrally positioned projection 16, the projection 16 and cap assembly 18 thus forming a T-shaped extension projecting outward from the tubular portion. This arrangement defines an upper channel 20 and a lower channel 22 on opposite sides of the projection 16 between the inner side of the cap assembly 18 nearest the building structure and the outer side 14a of the frame member's tubular portion 14. In this conventional frame member structure, the upper channel 20 is arranged to house the bottom peripheral edge of a glass unit installed above the horizontal frame member, with the equally wide lower channel 22 similarly arranged to house the top peripheral edge of a glass unit installed below the horizontal frame member.

In the illustrated embodiment, the frame member of the existing curtain wall is dimensioned to support double pane insulated glass units in its channels 20, 22 between gaskets 23 fitted on opposite sides of each channel to extend therealong, specifically on the outer side 14a of the frame member's tubular portion 14 and a pressure plate 24 fastened to the distal end 16a of the projection 16 thereof to define the inner side of the cap assembly and the outer side of each channel. In the illustrated embodiment, the pressure plate is fastened in place in a conventional manner by bolt 25 engaged into a threaded bore extending into the projection 16 from the distal end 16a. In the FIGURE, the originally or previously installed double pane insulated glass units, for which the existing conventional curtain wall framing was designed, have been removed and replaced with triple pane insulated glass units 12 designed in accordance with the present invention to fit the existing curtain wall framing without modification thereof. In the FIGURE, the top end 12a of one such triple glass unit 12 installed below the frame member 10 and the bottom end 12b of another such triple glass unit 12 installed above the frame member 10 are shown. It will be appreciated that the two illustrated glass units are identical in construction, and that the description of the illustrated bottom and top ends applies to each of the two glass units of the illustrated embodiment.

Each sealed triple glass unit 12 features a first outer glass pane 28, a second middle glass pane 30 and a third inner glass pane 32, positioned in this order from nearest the cap assembly 18, to define the exterior side of the installation distal to the building structure to which the curtain wall is anchored, to inwardly furthest from the cap assembly 18 to define the interior side of the installation forming a boundary of the resulting building interior space nearest the building structure.

The planar outer and middle panes 28, 30 have the same planar dimensions and shape and have their perimeters aligned, or in other words are equally sized panes axially aligned to share a common central axis normal to the parallel vertical planes in which their faces or surfaces lie. The outer and middle panes 28, 30 are sealed together in a conventional manner along their aligned peripheral edges by, for example, butyl sealant 34 applied within the perimeters of the aligned panes during manufacture, so that the seal 34 encloses the airspace between the spaced apart outer and middle panes 28, 30 along the boundary of this airspace sharing the same common periphery or perimeter as these two panes. In a conventional a manner, spacers 35, for example aluminum spacer bars, disposed between the outer and middle panes 28, 30 along the aligned peripheral edges thereof against the inner side of the peripheral seal 34 to maintain the spacing between the outer and middle panes.

The inner pane 32 and the middle pane 30 are similarly sealed together with an airspace therebetween, so that the outer and middle panes 28, 30 form a first pair of adjacent parallel panes and the middle and inner panes 30, 32 form a second pair of adjacent parallel panes, these adjacent pairs being non-exclusive pairs in that the middle pane 30 forms one half of each pair. However, the second adjacent pair of panes 28, 30 is different from the first in that the planar inner pane 32 is of smaller planar dimensions than the equally sized outer and middle panes 28, 30. This smaller inner pane 32 is axially aligned with the outer and middle panes 28, 30, which together with the smaller size thereof acts to position the smaller pane 32 inward from the common periphery shared by the sealed together outer and middle panes 28, 30. The peripheral edges of the smaller inner pane 32 are thus offset inwardly from those of the outer and middle panes. The seal 34a formed between the inner pane 32 and the middle pane 30 thus extends between this second pair of adjacent panes along the periphery of the smaller inner pane 32 inside the perimeter of its planer face to define a periphery of the second pair of adjacent panes 30, 32 formed by the inner pane's periphery and the seal 34a generally flush therewith.

The spacing between the outer and middle panes 28, 30 defining the first pair of adjacent panes and the thickness of these two panes are selected so that their overall thickness is equal or similar enough to the original double pane insulated glass of the existing curtain wall so as to fit the bottom end of this first pair of spaced-apart adjacent panes 28, 30 within the upper channel 20 of the frame member 10 between the gaskets 23 engaged to the sides of the channel to create a seal between the channel sides and the first pair of adjacent panes 28, 30. As shown, this first pair of sealed adjacent panes 28, 30 may sit atop a setting block 36 disposed on the projection 16 in the upper channel 20.

The distance by which the bottom edge of the smaller inner pane 32 is offset vertically upward from the parallel bottom edge of the middle pane 30 is sufficient so that when the outer and middle panes 28, 30 are situated on the setting block 36 in the upper channel 20, this bottom perimeter edge of the inner pane 28 is situated above the frame member 10 at a position between the upper channel 20 and the building structure to which the curtain wall is fixed. The inner pane 32 is thus positioned inward from the channel into which the outer and middle panels extend toward the building interior space to be covered by the triple glass unit 10, at a position over the top side 14b of the periphery of the tubular portion 14 of the frame member 10 from which the upper channel 20 formed between the tubular portion 14 and the cap assembly 18 depends or is recessed vertically downward.

An additional setting block 38 is inserted below the bottom peripheral edge of the inner pane 32 and the corresponding seal 34a between these features and the top side 14b of the frame member's tubular portion 14 to support the inner pane 32 and the sealed airspace between the inner pane 32 and middle pane 30. To visually conceal or cover the gap between the existing aluminum profile frame member and the new triple glass unit 12 installed to replace the original or previously installed double glass unit at the smaller new unit's inner pane 32, a glazing stop 40 of rectangular cross section is fixed to the top side 14b of the frame member's rectangular tubular portion 14 on a side of the inner pane 32 opposite the middle pane 30 spaced slightly from the inner pane 32 to extend along the horizontal frame member and project upward therefrom a greater height than the gap containing the additional setting block 38. In the illustrated embodiment, the stop 40 is of a known type having a base 42 fastened, for example by screws 43 threaded through it, tight and flush against the top side 14b of the frame member profile and a cover 44 that clips down onto the base to complete the rectangular outer shape of the stop's cross section and hide the fastened base 42. The stop 40 incorporates weather stripping 46 spanning from a side of the cover 44 nearest and facing the inner pane 32 to the inner pane to provide an extra barrier between the outside environment beyond the outer pane 28 and the interior space of the building closed off by the triple glass unit 12, thereby providing extra protection from air infiltration.

The airspace left between the second pair of adjacent panes 30, 32 is greater in thickness to space these panes apart sufficient to house a set of Venetian blinds, illustrated schematically and indicated generally at 50. As is known for other insulating glass units incorporating Venetian blinds between two panes, a housing 52 is supported between the two panes 30, 32 to extend along the top peripheral edge thereof on the interior side of the seal 34 and house an a motorized or manual operating mechanism represented schematically at 54. This mechanism 54 is operable in a known manner to move ladder and hoist cables, represented schematically at 56, to lift, lower and tilt a plurality of slats 58 carried thereon for movement of the slates between a lowered and closed condition, a lowered and open position and a raised position. The slats may, for example, be made of made of aluminum or solar proof film. The housing 52 of the blinds 50 not only supports the operating mechanism 54 and obscures it from sight, but also acts as a spacer bar along the top peripheral edge of the sealed space defined between the inner and middle panes 32, 30. Elsewhere along the periphery of this space, an aluminum (for example) spacer bar with absorbent is used in the illustrated embodiment, as shown at 60.

As is known to those of skill in the art, by pressing the outer and middle panes 28, 30 together during manufacture of the sealed unit may be performed at temperatures below minus 20° C. and/or in an elevated pressure environment, as is known in the art to provide resistance to sagging of the outer pane 28 toward the middle pane 30 under exposure to high pressure conditions exerted by outdoor environmental conditions on the outer pane after installation. As some sagging or movement of the outer pane 28 toward the middle pane 30 may occur after installation of the unit as a result of a difference between the outdoor air pressure outside the building and the indoor air pressure within the building's interior space enclosed by the glass unit, the Venetian blinds are installed instead between the inner pane 32 and the middle pane 30 to avoid a potential tendency of the slats to stick to the glass between the panes, as may occur when portions of the gap or airspace between the outer and middle panes 28, 30 narrow under such pressure-induced sagging or movement.

Although the FIGURE only shows the top and bottom triple glass units 12, illustrating the receipt of the top and bottom peripheral edges of the first pair of adjacent panes 28, 30 of each sealed unit projecting into the respective lower and upper channels 20, 22 of a single horizontal frame member 10 with the second pair of adjacent panes 30, 32 of each sealed unit having the periphery of the space between this second pair of panes inwardly offset from the periphery of the first pair of panes to allow the inner pane 32 to rest inward from the channel relative to the interior space of the building structure between two horizontal frame members defining the top and bottom of a window frame, it will be appreciated that the side peripheral edges of each sealed unit have the similar stepped or offset arrangement to fit the correspondingly smaller inner pane 32 between two vertical frame members having corresponding gasket-equipped vertical channels into which the outer and middle panes 28, 30 also extend for sealed support.

It will be appreciated that sealed glass units having a stepped arrangement of differently sized panes could be similarly be used to upgrade single pane curtain walls, in which case middle pane 30 would have the same smaller size as inner pane 32, with only outer pane 28 being larger and being housed between gaskets 23 in the channels of the four members defining the particular window frame in which the unit is installed. An upgrade to a single pane curtain wall could instead upgrade to only a double pane insulated glass unit, one of the two panes being larger to define the outer pane received in the channel and the other pane being smaller to form an adjacent inner pane offset from the larger pane to be recessed back into the window frame from the channel. Furthermore, a quadruple pane unit could potentially be produced, for example by having an additional innermost pane of the second smaller size added to the illustrated three pane arrangement further inward relative to the building interior to form a third pair of adjacent panes, the Venetian blinds being instead incorporated between the panes of this third pair and the stop 40 engaging with the innermost or further pane. As illustrated by these examples, a sealed unit for upgrading an existing current wall having channels sized to receive glass units of N panes may be upgraded to feature at least N+1 panes, with N of these panes being of sizes suitable for receipt in the channels and the remaining panes being of smaller sizes and inwardly offset from the peripheries of the larger panes for positioning inward from the channels relative to the building interior space along the window frame defining surfaces of the frame members to which the unit is to be installed.

An existing curtain wall can thus be upgraded by manufacturing a sealed unit of a type described herein above to have at least one more pane than a type of glass unit for which the curtain wall was originally intended, removing the cap assemblies clamping a previously installed glass unit in place, removing the previously installed glass unit, placing the larger pane(s) of the new glass unit between the projections of the frame members to thereby situate the smaller pane(s) between the tubular portions of the frame members, and reinstalling the cap assemblies to secure the new windows in place. Where it is desirable to retain the original exterior appearance of the building, the panes sized for receipt in the channels should be made of the same type of glass that was previously used in the curtain wall. It will also be appreciated that the blinds need not be included in order to upgrade the insulation effect of a curtain wall by installation prefabricated sealed insulated glass units each having more panes of glass than the previously installed glass units. The glass units of the present invention can be pre-fabricated at a factory in accordance with the standard insulated glass manufacturing regulations.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A sealed glass unit prefabricated for installation on an existing curtain wall frame having framing members defining channels of suitable width to receive a glass unit of N glass panes, the sealed glass unit comprising:
a plurality of glass panes interconnected to be movable together as a single assembled unit and comprising N+1 glass panes, adjacent panes of the plurality of glass panes being in spaced apart and parallel relationships with one another;
the plurality of glass panes comprising an outer glass pane of a first size and at least one smaller glass pane of a second size smaller than the first size, the smaller glass pane being positioned inward from a peripheral edge of the outer glass plane; and
the adjacent panes being sealed together along a perimeter of a space defined therebetween.

2. The sealed glass unit according to claim 1 wherein the plurality of glass panes comprises a middle pane disposed between and sealed to each of the outer glass pane and the small glass pane.

3. The sealed glass unit according to claim 2 wherein the middle pane is generally equal in size to the outer pane and in general alignment therewith, the small pane being inwardly offset from a periphery of the aligned outer and middle panes.

4. The sealed glass unit according to claim 3 wherein the middle pane and the small pane are sealed together along outside edges of the small pane.

5. The sealed glass unit according to claim 1 further comprising a window covering mechanism installed in the space defined between a respective pair of adjacent panes and operable between closed and open conditions.

6. The sealed glass unit according to claim 2 further comprising a window covering mechanism installed between the inner and middle glass panes and operable between closed and open conditions.

7. The sealed glass unit according to claim 5 wherein the window covering mechanism comprises Venetian blinds operable between raised and lowered conditions.

8. The sealed glass unit according to claim 1 wherein the plurality of glass panes comprises three glass panes.

9. The sealed glass unit according to claim 1 wherein the plurality of glass panes consists of N+1 glass panes.

10. The sealed glass unit according to claim 1 wherein the plurality of glass panes consists of three glass panes.

11. The sealed glass unit according to claim 1 wherein N=2.

12. The sealed glass unit according to claim 1 wherein N=1.

13. A method for upgrading an existing curtain wall of a building, the curtain wall having framing members defining channels in which previously installed glass units each using N glass panes are received, the method comprising the steps of:
(a) manufacturing a sealed glass unit comprising N+1 glass panes arranged with adjacent panes in spaced apart, sealed and parallel relationships with one another, the N+1 panes comprising an outer glass pane of a first size and at least one smaller glass pane of a second size smaller than the first size, the smaller glass pane being positioned inward from a peripheral edge of the outer glass plane;
(b) removing one of the previously installed glass units from corresponding framing members of the existing curtain wall;
(c) installing the sealed glass unit on the existing curtain wall to position outside edges of N out of the N+1 glass panes of the sealed unit, including the outer glass pane, into the channels of the corresponding framing members and position each remaining pane at a position further inward relative to an interior space of the building along surfaces of the corresponding framing members from which the channels thereof are recessed.

14. The method according to claim 13 wherein the sealed glass unit comprises installing a window covering mechanism installed between a respective pair of adjacent panes.

15. The method according to claim 14 wherein the respective pair of adjacent panes does not comprise the outer glass pane.

16. The method according to claim 15 wherein step (a) comprises sealing the outer pane to a middle pane adjacent thereto at a temperature below −20 degrees Celsius.

17. The method according to claim 15 wherein step (a) comprises sealing the outer pane to a middle pane adjacent thereto at a pressure above an intentionally elevated air pressure greater than a naturally occurring range of atmospheric pressure.

18. The method according to claim 13 wherein the N+1 glass panes comprise three glass panes.

19. The method according to claim 13 wherein the sealed glass unit has only the N+1 glass panes.

20. The method according to claim 13 wherein the N+1 glass panes consist of three glass panes.
